(19) United States
(12) Patent Application Publication
(10) Pub. No.: US 2026/0252410 A1
(43) Pub. Date: Aug. 27, 2026

(54) APP driving apparatus for minimizing system resource occupancy

(71) Applicant: EdgeDX Co., Ltd., Seoul (KR)

(72) Inventor: Dong Uk PARK, Seoul (KR)

(73) Assignee: EdgeDX Co., Ltd., Seoul (KR)

(21) Appl. No.: 19/401,475

(22) Filed: Nov. 26, 2025

(30) Foreign Application Priority Data
Feb. 21, 2025 (KR) 10-2025-0022717

(51) Int. Cl. G06F 9/50

(52) U.S. Cl. CPC G06F 9/5077; G06F 9/5016; G06F 2209/503

(57) ABSTRACT

Provided is an artificial intelligence (AI) application (app) driving apparatus for minimizing system resource occupancy, which is capable of performing a specific function while minimizing system resource occupancy by associating some functions of at least two existing independent AI apps with one another to generate a virtual AI app with a relatively small memory footprint, rather than generating a new AI app for performing the specific function.

### CROSS-REFERENCE TO RELATED APPLICATION(S)

This application claims priority from Korean Patent Application No. 10-2025-0022717, filed on Feb. 21, 2025, in the Korean Intellectual Property Office, the disclosure of which is incorporated herein by reference in its entirety.

### BACKGROUND

### 1. Field

The following description relates to artificial intelligence (AI) technology, and more particularly, to an AI application (app) driving apparatus for minimizing system resource occupancy.

### 2. Description of Related Art

Recently, various artificial intelligence (AI) applications (apps) utilizing AI technology have emerged. These AI apps analyze input data and detect feature data using models trained using supervised or unsupervised learning methods.

However, programming a new AI app for a specific function desired by a client is inefficient in terms of time and cost. Even if the new AI app is programmed for the specific function desired by the client, the system resource occupancy required to execute the new AI app is extremely high.

Therefore, the present inventors have conducted research on a technology capable of performing a specific function while minimizing system resource occupancy by associating some functions of at least two existing independent AI apps with one another to generate a virtual AI app with a relatively small memory footprint, rather than generating a new AI app for performing the specific function.

### RELATED ART

### Patent Literature

Korean Laid-Open Patent Publication No. 10-2021-0147865 (published on Dec. 7, 2021)

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present disclosure is directed to providing an artificial intelligence (AI) application (app) driving apparatus capable of performing a specific function while minimizing system resource occupancy by associating some functions of at least two existing independent AI apps with one another to generate a virtual AI app with a relatively small memory footprint, rather than generating a new AI app for performing the specific function.

According to an aspect of the present disclosure, there is provided an AI app driving apparatus for minimizing system resource occupancy, which includes: a nonvolatile memory configured to store at least two independent AI apps; a processor configured to execute the at least two independent AI apps stored in the nonvolatile memory; and a volatile memory in which a buffer memory used by the at least two independent AI apps executed by the processor is dynamically allocated, wherein the processor may be implemented to generate a virtual AI app having system resource occupancy that is relatively smaller than that of the at least two independent AI apps, by associating some functions of the at least two independent AI apps with one another.

According to an additional aspect of the present disclosure, a system resource may be computational resources of the virtual AI app.

According to an additional aspect of the present disclosure, a system resource may include a buffer memory that is dynamically allocated in the volatile memory for the virtual AI APP.

According to an additional aspect of the present disclosure, the processor may be implemented to execute a program code that configures the virtual AI app in which some functions of the at least two independent AI apps are associated with one another with reference to an association rule for associating some functions of the independent AI apps with one another.

According to an additional aspect of the present disclosure, the processor may be implemented to select at least one transaction item associated with another AI app from among transaction items, which are logical work units of the at least two independent AI apps according to the association rule, and configure the virtual AI app by determining an execution order of the selected transaction items.

According to an additional aspect of the present disclosure, the AI app driving apparatus for minimizing system resource occupancy may further include a user input unit configured to process a user input for defining the association rule.

According to an additional aspect of the present disclosure, the association rule may be recorded in metadata of each of the at least two independent AI apps.

According to an additional aspect of the present disclosure, the AI app driving apparatus for minimizing system resource occupancy may further include a communication unit configured to transmit processing results of the virtual AI app to an external device.

According to an additional aspect of the present disclosure, the AI app driving apparatus for minimizing system resource usage may further include a display configured to display the processing results of the virtual AI app.

Other features and aspects will be apparent from the following detailed description, the drawings, and the claims.

### BRIEF DESCRIPTION OF THE DRAWINGS

FIG. 1 is a block diagram illustrating the configuration of an artificial intelligence application (AI app) driving apparatus for minimizing system resource occupancy according to an embodiment of the present disclosure.

FIG. 2 is an exemplary diagram illustrating an association rule used in the AI app driving apparatus for minimizing system resource occupancy according to the present disclosure.

FIG. 3 is an exemplary diagram illustrating a virtual AI app in which some functions of independent AI apps generated by the AI app driving apparatus for minimizing system resource occupancy according to the present disclosure are configured in association with one another.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The foregoing and additional aspects are embodied through the embodiments described with reference to the accompanying drawings. It is to be understood that the components of each embodiment are capable of various combinations within the embodiments as long as they are not mutually exclusive or mutually contradictory. It will be understood that the terms used in this specification and claims should be interpreted to have meanings and concepts consistent with the content described or the technical idea proposed, based on the principle that an inventor may properly define the meanings of the words or terms to best explain the present disclosure.

The blocks referred to as “circuits” in the present specification may be implemented as hardware such as dedicated semiconductors, gate arrays, or field-programmable gate arrays (FPGAs), or as portions thereof. One or more blocks may be implemented as a single hardware component. In another example, these blocks may be implemented in software as an information processing device in which program instructions stored in a memory element are executed by a computing element. A plurality of blocks may be implemented as portions of a program executed by the same computing element.

In still another example, these blocks may be implemented in a hybrid form in which part of each individual circuit is realized in hardware and part is realized in software. In software-based implementations, the computing element may include, or may be any combination of, a digital signal processor, a computation-dedicated processor, an AI processing engine, an AI-dedicated processor, or a graphics processing unit.

Hereinafter, exemplary embodiments will be described in detail with reference to the accompanying drawings so that those skilled in the art may readily understand and reproduce the present disclosure. Although certain embodiments are illustrated in the drawings and described in detail, such embodiments are not intended to limit the various embodiments of the present disclosure to a particular form.

In the description of the embodiments, if it is determined that detailed description of a related known technology may unnecessarily obscure the gist of the embodiments, the detailed description thereof will be omitted.

When a component is referred to as being “connected” or “coupled” to another component, it may be directly connected or coupled to the other component, but it is to be understood that other components may exist in between.

On the other hand, when a component is referred to as being “directly connected” or “directly coupled” to another component, it is to be understood that there are no intervening components present.

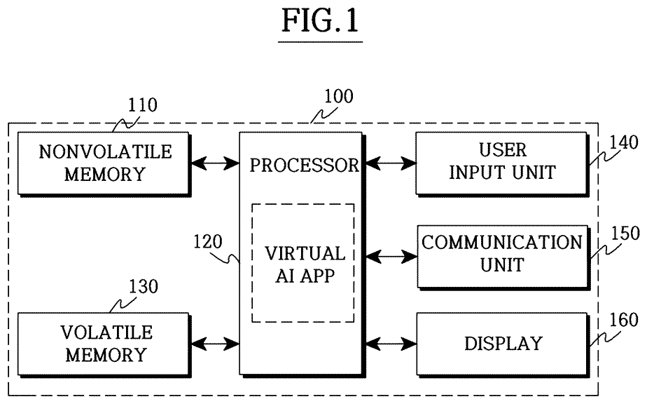

FIG. 1 is a block diagram illustrating the configuration of an artificial intelligence application (AI app) driving apparatus for minimizing system resource occupancy according to an embodiment of the present disclosure. As illustrated in FIG. 1, an AI app driving apparatus 100 for minimizing system resource occupancy according to this embodiment includes a nonvolatile memory 110, a processor 120, and a volatile memory 130.

The nonvolatile memory 110 stores at least two independent AI apps. In this case, the nonvolatile memory 110 may be implemented as a flash memory or an EEPROM, but is not limited thereto.

The processor 120 executes the at least two independent AI apps stored in the nonvolatile memory 110. The processor 120 may be a single-core processor or a multi-core processor.

The volatile memory 130 is a memory in which a buffer memory used by the at least two independent AI apps executed by the processor 120 is dynamically allocated. Here, the volatile memory 130 may be a random access memory (RAM), a dynamic RAM (DRAM), or a static RAM (SRAM), but is not limited thereto.

In this case, the processor 120 may be implemented to associate some functions of the at least two independent AI apps with one another to generate a virtual AI app whose system resource occupancy is relatively smaller than that of the at least two independent AI apps.

For example, the processor 120 may be implemented to execute program code that configures a virtual AI app in which some functions of at least two independent AI apps are associated with one another, with reference to an association rule for associating some functions of the independent AI apps with one another.

Meanwhile, the system resources may include computational resources of the virtual AI app, a buffer memory dynamically allocated in volatile memory for the virtual AI app, and a virtual memory dynamically allocated in nonvolatile memory for the virtual AI app, but are not limited thereto.

For example, it is assumed that the processor 120 executes an AI app for detecting a forklift from an image and outputting results, an AI app for detecting a person from an image and outputting results, and an AI app for detecting whether a person is wearing a helmet and outputting results.

For example, the processor 120 may associate a forklift-detection transaction, which is a partial function of the forklift-detection AI app, a person-detection transaction, which is a partial function of the person-detection AI app, and a helmet-detection transaction, which is a partial function of the helmet-detection AI app, to configure a virtual AI app that detects whether a forklift operator is wearing a helmet.

Then, the processor 120 may configure a virtual AI app that detects whether a forklift driver is wearing a helmet by associating a forklift detection transaction, which is a partial function of the forklift detection-AI app, a person detection transaction, which is a partial function of the person detection-AI app, and a helmet detection transaction, which is a partial function of the helmet detection-AI app.

When a separate AI application is programmed to detect whether a forklift operator is wearing a helmet, it may be inefficient in terms of time and cost. Even if such a separate AI application is programmed, system resources required to execute this new AI app may be excessively large.

However, through the present disclosure, when a virtual AI app with a relatively small memory footprint is generated by associating some functions of at least two existing independent AI apps with one another without generating a new AI app for performing a specific function, there is no need to develop a new AI app, and a new specific function may be performed while minimizing system resource occupancy.

By implementing the present disclosure in this manner, it is possible to perform a specific function while minimizing system resource occupancy by associating some functions of at least two existing independent AI apps with one another to generate a virtual AI app with a relatively small memory footprint, rather than generating a new AI app for performing the specific function.

Meanwhile, according to an additional aspect of the present disclosure, the processor 120 may be implemented to select at least one transaction item associated with another AI app from among transaction items, which are logical work units of the at least two independent AI apps, according to the association rule, and determine the execution order of the selected transaction items to configure a virtual AI app.

In this case, the association rule may be data defining some functions of another AI app associated with the independent AI apps when the independent AI apps are executed. For example, the association rule may be implemented to be recorded in the metadata of the at least two independent AI apps.

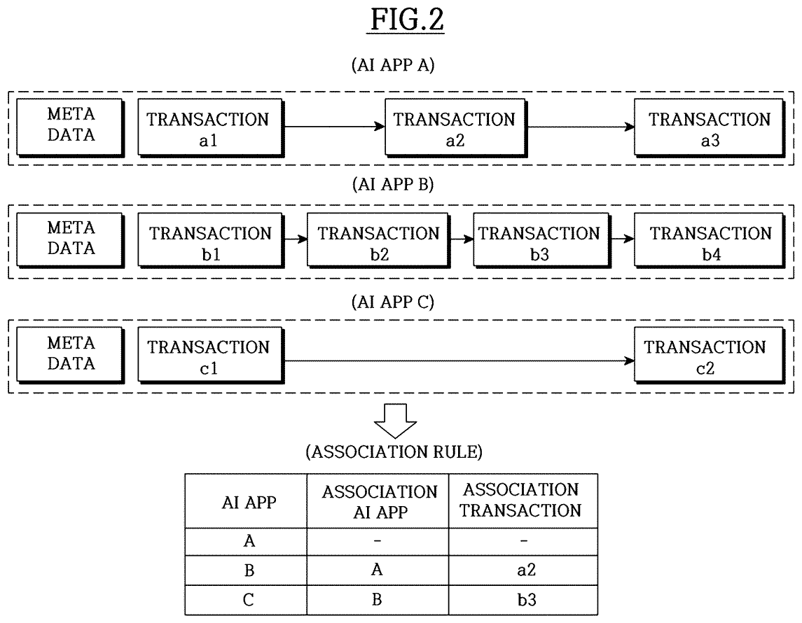

FIG. 2 is an exemplary diagram illustrating an association rule used in the AI app driving apparatus for minimizing system resource occupancy according to the present disclosure. It is assumed that AI application A is composed of transaction a1, transaction a2, and transaction a3, AI application B is composed of transaction b1, transaction b2, transaction b3, and transaction b4, and AI application C is composed of transaction c1 and transaction c2.

Referring to FIG. 2, it can be seen that an association rule in which the intermediate result of transaction a2 of AI app A is processed as input data upon execution of AI app B and the intermediate result of transaction b3 of AI app B is processed as input data upon execution of AI app C is defined in the metadata of the AI apps.

When the at least two independent AI apps are executed, the processor 120 generates a virtual AI app with a relatively small memory footprint by associating some functions of the at least two independent AI apps with one another, with reference to the association rule recorded in the metadata of the at least two independent AI apps.

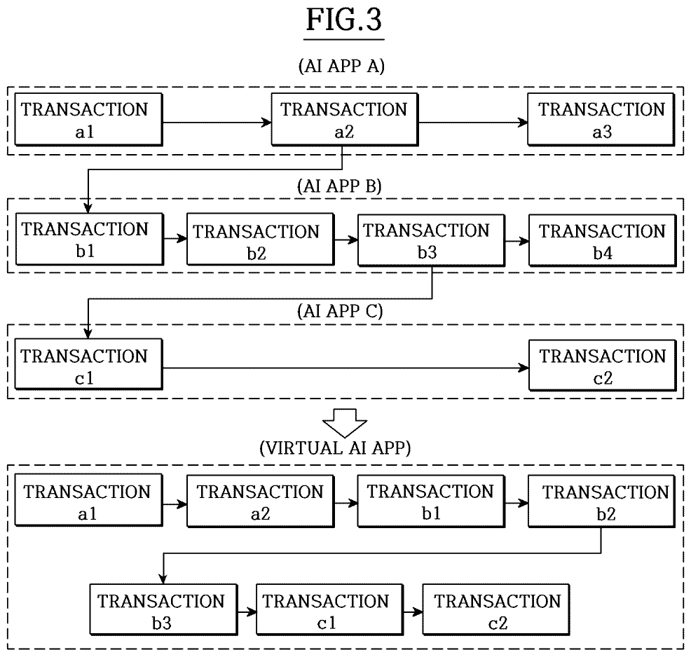

FIG. 3 is an exemplary diagram illustrating a virtual AI app in which some functions of independent AI apps generated by the AI app driving apparatus for minimizing system resource occupancy according to the present disclosure are configured in association with one another. Referring to FIG. 3, it can be seen that a virtual AI app in which the intermediate result of transaction a2 of AI app A is processed as input data upon execution of AI app B and the intermediate result of transaction b3 of AI app B is processed as input data upon execution of AI app C is configured.

By implementing the present disclosure in this manner, it is possible to perform a specific function while minimizing system resource occupancy by associating some functions of at least two existing independent AI apps with one another to generate a virtual AI app with a relatively small memory footprint, rather than generating a new AI app for performing the specific function.

Meanwhile, according to an additional aspect of the present disclosure, the AI app driving apparatus 100 for minimizing system resource occupancy may further include a user input unit 140. The user input unit 140 processes a user input for defining the association rule. The user input unit 140 may be a keyboard, mouse, touch panel, microphone, etc., but is not limited thereto.

By implementing the present disclosure in this manner, the AI app driving apparatus 100 for minimizing system resource occupancy may define and record an association rule in metadata of each of at least two independent AI apps through a user input by the user input unit 140.

Meanwhile, according to an additional aspect of the disclosure, the AI app driving apparatus 100 for minimizing system resource occupancy may further include a communication unit 150. The communication unit 150 transmits processing results of a virtual AI app to an external device. In this case, the communication unit 150 may be implemented to transmit the processing results of the virtual AI app to an external device via an Ethernet-based wired communication method or a Wi-Fi, Bluetooth, or ZigBee-based wireless communication method.

By implementing the present disclosure in this manner, the AI app driving apparatus 100 for minimizing system resource occupancy may transmit the processing results of the virtual AI app to an external device via the communication unit 150.

Meanwhile, according to an additional aspect of the disclosure, the AI app driving apparatus 100 for minimizing system resource occupancy may further include a display 160. The display 160 displays the processing results of the virtual AI app on a screen. In this case, the display 160 may be an LED, OLED, etc., but is not limited thereto.

By implementing the present disclosure in this manner, the AI app driving apparatus 100 for minimizing system resource occupancy may display the processing results of the virtual AI app through the display 160.

As described above, according to the present disclosure, it is possible to perform a specific function while minimizing system resource occupancy by associating some functions of at least two existing independent AI apps with one another to generate a virtual AI app with a relatively small memory footprint, rather than generating a new AI app for performing the specific function.

The present disclosure has the effects of performing a specific function while minimizing system resource occupancy by associating some functions of at least two existing independent AI apps with one another to generate a virtual AI app with a relatively small memory footprint, rather than generating a new AI app for performing the specific function.

The various embodiments disclosed in this specification and drawings are merely specific examples to aid understanding and are not intended to limit the scope of various embodiments of the present disclosure.

Therefore, the scope of various embodiments of the present disclosure should be interpreted to include all modifications or variations derived from the technical concepts of various embodiments of the present disclosure, in addition to the embodiments described herein.

### INDUSTRIAL APPLICABILITY

The present disclosure is industrially applicable in the fields of artificial intelligence (AI)-related technologies and their application fields.

What is claimed is:

1. An artificial intelligence (AI) application (app) driving apparatus for minimizing system resource occupancy, comprising:
a nonvolatile memory configured to store at least two independent AI apps;
a processor configured to execute the at least two independent AI apps stored in the nonvolatile memory; and
a volatile memory in which a buffer memory used by the at least two independent AI apps executed by the processor is dynamically allocated,
wherein the processor is implemented to generate a virtual AI app having system resource occupancy that is relatively smaller than that of the at least two independent AI apps, by associating some functions of the at least two independent AI apps with one another.

2. The AI app driving apparatus of claim 1, wherein a system resource is a computational resource of the virtual AI app.

3. The AI app driving apparatus of claim 1, wherein a system resource includes the buffer memory that is dynamically allocated in the volatile memory for the virtual AI app.

4. The AI app driving apparatus of claim 1, wherein a system resource includes a virtual memory that is dynamically allocated in the nonvolatile memory for the virtual AI app.

5. The AI app driving apparatus of claim 1, wherein the processor is implemented to execute a program code that configures the virtual AI app in which some functions of the at least two independent AI apps are associated with one another with reference to an association rule for associating some functions of the independent AI apps with one another.

6. The AI app driving apparatus of claim 5, wherein the processor is implemented to select at least one transaction item associated with another AI app from among transaction items, which are logical work units of the at least two independent AI apps according to the association rule, and configure the virtual AI app by determining an execution order of the selected transaction items.

7. The AI app driving apparatus of claim 5, further comprising:
a user input unit configured to process a user input for defining the association rule.

8. The AI app driving apparatus of claim 7, wherein the association rule is recorded in metadata of each of the at least two independent AI apps.

9. The AI app driving apparatus of claim 5, further comprising:
a communication unit configured to transmit processing results of the virtual AI app to an external device.

10. The AI app driving apparatus of claim 5, further comprising:
a display configured to display processing results of the virtual AI app.
